(19) United States
(12) Patent Application Publication
(10) Pub. No.: US 2025/0023437 A1
(43) Pub. Date: Jan. 16, 2025

(54) Magnetohydrodynamic Power Generation System

(71) Applicants: William Vincent Torre, Chula Vista, CA (US); Christopher Nolan Torre, Sherwood, AR (US)

(72) Inventors: William Vincent Torre, Chula Vista, CA (US); Christopher Nolan Torre, Sherwood, AR (US)

(21) Appl. No.: 18/771,518

(22) Filed: Jul. 12, 2024

Related U.S. Application Data
(63) Continuation-in-part of application No. 16/949,919, filed on Nov. 20, 2020, now abandoned.

(51) Int. Cl. H02K 44/16; B64G 1/42; H02K 11/33

(52) U.S. Cl. CPC H02K 44/16; B64G 1/421; H02K 11/33

(57) ABSTRACT

A magnetohydrodynamic (MHD) power generation system for powering an electrical system of a spacecraft using space plasma. The system includes an MHD generator and a power control unit. The MHD generator includes an MHD channel and a plasma scoop in fluid communication with the MHD channel. The MHD channel includes a channel oriented in a first direction, magnets operable to provide a magnetic field inside the channel in a second direction orthogonal to the first direction, and electrodes disposed inside the channel within the magnetic field in a third direction orthogonal to the first and second directions. The plasma scoop may be formed by a funnel fitted over the outer periphery of a plasma guide and is operable to direct a flow of space plasma into the channel to pass orthogonally through the magnetic field, generating electrical power output through the electrodes. The electrodes are electrically coupled to the electrical system of the spacecraft via a power control unit, which manages the electrical power output to the electrical system of the spacecraft. A method of using the system for powering an electrical system a spacecraft is also described.

### CROSS-REFERENCE TO RELATED APPLICATIONS

This application is a continuation in part of U.S. patent application Ser. No. 16/949,919, entitled “SYSTEM AND METHOD FOR CONVERTING SPACE-BASED IONIZED PLASMA INTO ELECTRICAL POWER FOR SPACECRAFT USING MAGNETOHYDRODYNAMIC GENERATION,” filed on Nov. 20, 2020, which claims priority to U.S. Provisional Application No. 62/958,660, filed on Jan. 8, 2020. The disclosures of the aforesaid applications are considered part of and are incorporated by reference in the disclosure of this application in their entireties.

### STATEMENT REGARDING FEDERALLY SPONSORED RESEARCH OR DEVELOPMENT

This invention was made with government support under Grant No. 2136159 awarded by the National Science Foundation. The U.S. government has certain rights in this invention.

### BACKGROUND OF THE INVENTION

The electrical systems of spacecrafts, such as space shuttles and other space vehicles, typically require electrical power provided at a constant direct-current (“DC”) voltage to operate. Photovoltaic panels are often used to supply electrical power to the electrical systems of spacecrafts. Photovoltaic panels, however, include components that are bulky, fragile, heavy, and degrade from free atomic oxygen exposure, posing durability risks and potential issues conforming to spacecraft weight limitations. Additionally, during various periods of space travel, the photovoltaic panels may not be sufficiently exposed to photons to generate the power necessary to satisfy the electrical power drawn by the electrical system of the spacecraft for operations. For example, photovoltaic panels are not exposed to photons while the spacecraft is in orbit in the shadow of the earth. A durable, lighter, and consistent system for supplying electrical power to the spacecraft at a constant DC voltage is thus desirable.

Ionized plasma produced in the upper atmosphere of the sun (space plasma) is naturally present in solar wind and at any of a variety of orbits of earth, such as a low earth orbit (LEO), a medium earth orbit (MEO), and a geosynchronous earth orbit (GEO). Various magnetohydrodynamic (“MHD”) power generation systems have been used to produce electrical power from artificial plasma flows having consistent densities, temperatures, velocities, and directions. Space plasma, however, varies in density, temperature, velocity, and direction, which can result in significant fluctuations in the electrical power produced by traditional MHD power systems. Accordingly, it is desirable to have an MHD power system operable to produce electrical power at a constant DC voltage from a flow of naturally-occurring space plasma regardless of variations in density, temperature, velocity, and flow direction. The MHD power system of the present invention solves one or more of the issues set forth above.

### SUMMARY OF THE INVENTION

One aspect of the present invention is directed to an MHD power system which may be used to power an electrical system of a spacecraft from a flow of space plasma. The MHD power system includes a plasma scoop and an MHD channel. The MHD channel includes a channel oriented in a first direction and electromagnets mounted on opposite sides of the channel to produce a magnetic field inside the channel in a second direction orthogonal to the first direction. The MHD channel may also include at least one permanent magnet. The plasma scoop is operable to direct and accelerate a flow of space plasma from space through the MHD channel to pass orthogonally through the magnetic field inside the channel, generating electrical power. Electrodes of the MHD channel are provided on internal surfaces of the channel within the magnetic field in a direction orthogonal to the magnetic field inside the channel and the flow of space plasma such that the electrical power is output through the electrodes. The MHD channel may be accommodated inside an enclosure to prevent the magnetic field from interfering with signals or components of the spacecraft.

The MHD power system preferably includes a power control unit to manage the electrical power generated and output by the MHD power system. The power control unit includes a voltage regulating circuit, an electromagnet control circuit, a plasma guide control circuit, and a controller. Operating logic that defines various power control, management, and/or regulation functions is stored in a memory device of the controller and referenced by a processor of the controller to execute the operating logic. Electrode rings of the plasma scoop, and the electromagnets of the MHD channel, may be electrically coupled to the power control unit to control the electrical power output by the MHD power system in response to the operating logic to account for changes in space plasma conditions and in the electrical power demand of the spacecraft. The electrodes of MHD channel may be electrically connected to the electrical system of the spacecraft through the voltage regulating circuit to output electrical power to the electrical system at a constant DC voltage suitable for powering its operations. In various embodiments, the plasma scoop may be adjustably positioned to capture the flow of ionized plasma. For example, in LEO, the inlet of the plasma scoop may be adjustably oriented in the direction in which the spacecraft is traveling. In MEO, GEO or interplanetary space, the inlet of the plasma scoop may be adjustably oriented in the direction from which the optimal flow of space plasma is received by the plasma scoop.

In another general aspect, the present invention is directed to a method of using the MHD power system to power a spacecraft. The method includes directing via the plasma scoop a flow of space plasma orthogonally through the magnetic field inside the MHD channel, outputting electrical power from the electrodes of the MHD channel to electrical system of a spacecraft through the voltage regulating circuit and powering the electrical system of the spacecraft by outputting the electrical power to the electrical system at the constant DC voltage. The method may further include the steps of monitoring the electric current demand of the spacecraft and adjusting one of the magnetic field inside of the MHD channel and the voltage gradient inside of the plasma scoop to match the electrical current of electrical power output by the MHD power system to the electrical current drawn by the electrical system of the spacecraft.

### BRIEF DESCRIPTION OF THE DRAWINGS

FIG. 1 shows a perspective view of an exemplary embodiment of a plasma scoop operably associated with an MHD channel according to an aspect of the present.

FIG. 2 shows top perspective cross-sectional view of an exemplary embodiment of an MHD channel and a portion of a plasma scoop according to an aspect of the present invention.

FIG. 3 shows a side perspective cross-sectional view of an exemplary embodiment of an MHD channel and a portion of a plasma scoop according to an aspect of the present invention.

FIG. 4 shows a schematic diagram of an exemplary embodiment of a MHD power system according to an aspect of the present invention.

FIG. 5 shows a schematic diagram of an exemplary embodiment of a MHD power system according to an aspect of the present invention.

FIG. 6 is a diagram of an exemplary embodiment of a portion of a power control unit, including a controller, a plasma guide control circuit, an electromagnet control circuit, a voltage sensor, and a density sensor, according to an aspect of the present invention.

FIG. 7 shows a diagram of an exemplary embodiment of an electromagnet control circuit according to an aspect of the present invention.

FIG. 8 is a schematic diagram of an exemplary embodiment of a plasma scoop according to an aspect of the present invention.

FIG. 9 is a diagram of an exemplary embodiment of a voltage regulating circuit according an aspect of the present invention.

FIG. 10 is a diagram of an exemplary embodiment of operating logic for managing or controlling electrical power generated and output by an MHD power system according to an aspect of the present invention.

### DETAILED DESCRIPTION

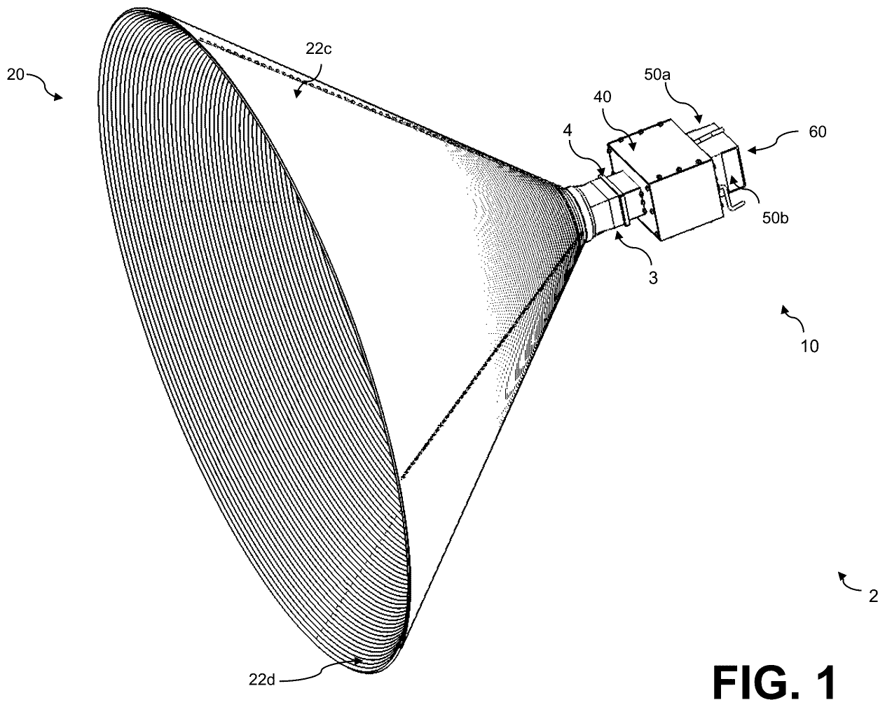

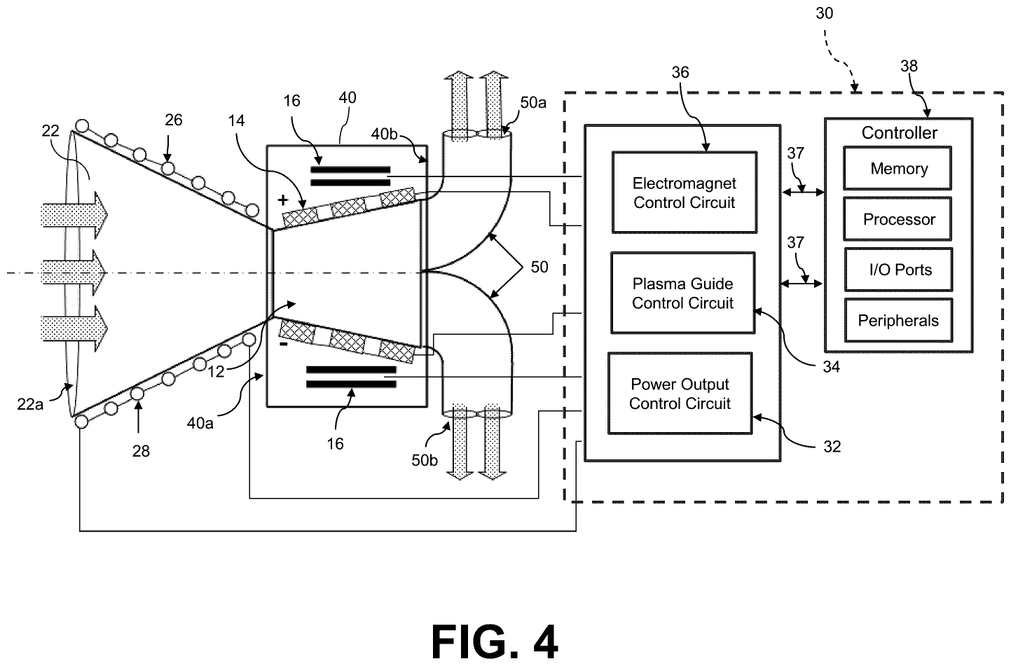

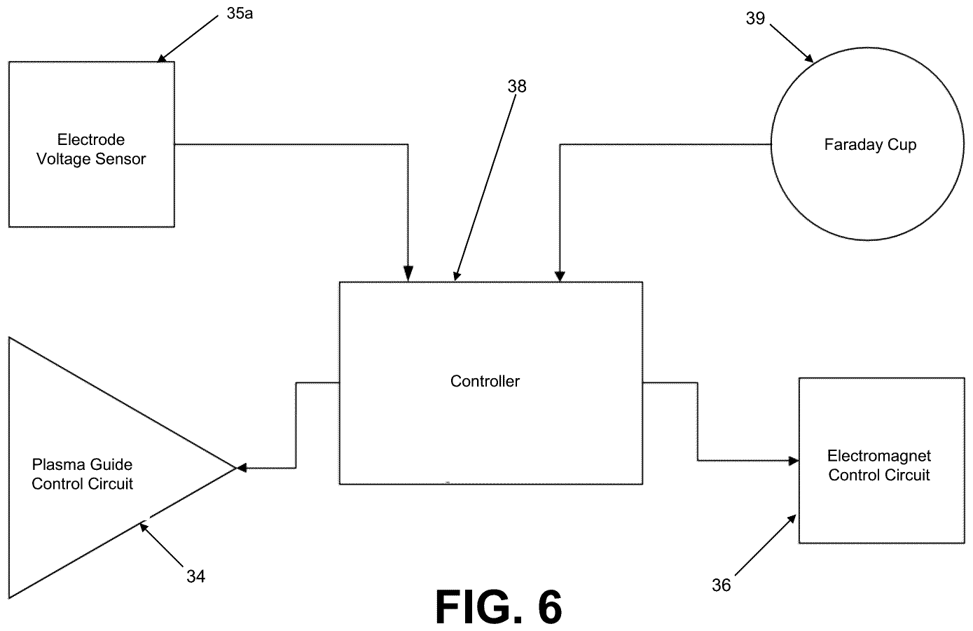

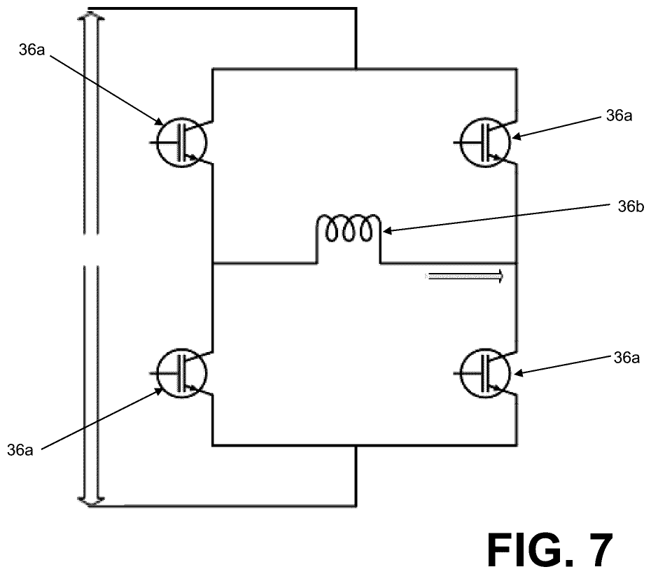

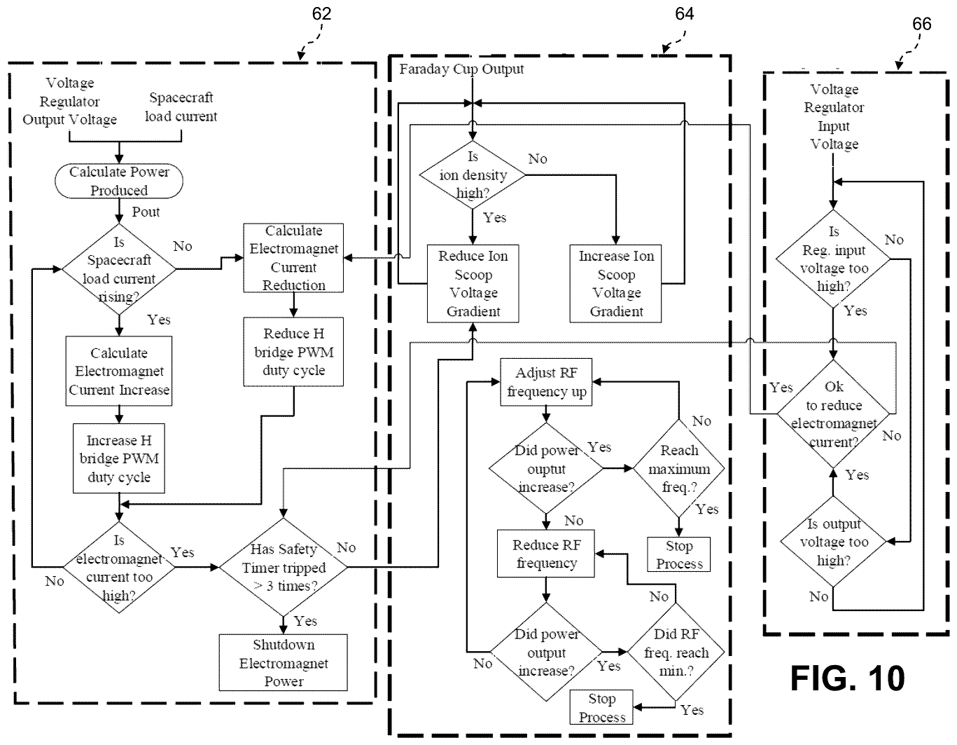

Various exemplary embodiments of an invention will be disclosed hereinafter with frequent reference to FIGS. 1, 2, 3, 4, 5, 6, 7, 8, 9, and 10. For simplicity and clarity of illustration, elements indicated therein are not necessarily drawn to scale, and reference labels have been repeated thereamong to indicate analogous elements. Each embodiment is disclosed for the purpose of enabling persons of ordinary skill in the art to appreciate and understand the principles and practices of the present invention. It is to be understood, however, that all of such embodiments are merely examples and not intended to limit the scope of the present invention.

The present invention is directed generally to a magnetohydrodynamic (MHD) power system 1 for powering an electrical system of a spacecraft using a flow of space plasma. Space plasma includes ionized plasma of solar wind, as well as such ionized plasma particles that depart or diverge from solar wind into a magnetosphere and/or ionosphere surrounding a planet. Space plasma generally has a lower temperature and density, and travels at higher velocity, than plasmas artificially produced on earth. For example, space plasma may travel at a velocity of at least about 7,800 m/s, be of a density within a range of about 100 ions/m³ to about 600 ions/m³, and at plasma particle kinetic temperatures of approximately 4×10⁴° K for protons and 4×10⁵° K for electrons. Thus, the properties or characteristics of space plasma can be highly variable.

MHD power system 1 may be operably associated with a spacecraft. A spacecraft may be embodied by a space vehicle, a space shuttle, satellite, probe, station or any other suitable type of vehicle, vessel, or machine configured to perform operations in space. The spacecraft generally includes a spacecraft bus and a plurality of systems, which may include, for example, a propulsion system and an electrical system. The electrical system of a spacecraft typically has an electrical distribution bus through which electrical power is distributed to various electrical loads, such as lighting, batteries, appliances, electronics, communication systems, and other equipment and devices as would be found on a spacecraft. Correspondingly, the equipment and devices electrically load the spacecraft. The electrical system of a spacecraft is generally configured to be powered by electrical power at a constant DC voltage of 28 VDC or 120 VDC and a current (Iₚₒᵤₜ) that varies based on the electrical loading of the spacecraft. As will be more fully described herein, MHD power system 1 detects the electrical power drawn by the electrical system of a spacecraft and generates electrical power at a voltage and current equivalent to the electrical power drawn by the electrical system of the spacecraft.

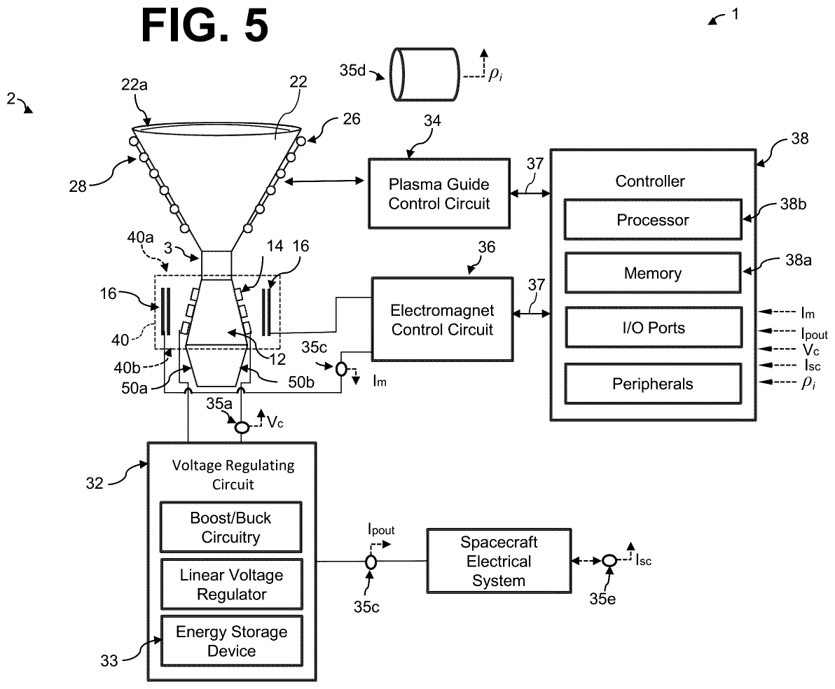

FIG. 5 shows an exemplary embodiment of MHD power system 1. Referring to FIG. 5, MHD power system 1 includes an MHD power generator 2 and a power control unit 30. As shown in FIG. 1, MHD power generator includes a plasma scoop 20 and an MHD channel 10. MHD channel 10 and scoop 20 are mounted to an exterior surface of the spacecraft bus. Scoop 20 is operable to direct a flow of space plasma from space through MHD channel 10. Scoop 20 includes a conical funnel 22 or other converging body made of a polymeric material (e.g., kapton, polyurethane, fabric or laminated composite material, or any other polymeric material suitable for space). Funnel 22 has a frustoconical outer peripheral surface 22c and a frustoconical inner peripheral surface 22d parallel to frustoconical outer peripheral surface 22c. In addition, funnel 22 defines an inlet 22a and an exit 22b opposite of inlet 22a, and an inner radius that decreases linearly moving from inlet 22a to exit 22b. Scoop 20 also includes a plasma guide 24 within funnel 22 fitted to frustoconical inner surface 22d. In various embodiments, scoop 20 may be compactible to minimize the size of scoop 20 when stowed in the spacecraft. For example, scoop 20 may be collapsable such that larger rings 24a may concentrically surround smaller rings 24a to form a flat pancake-like stack. Alternatively, the funnel 22 may be supported by foldable polymeric rods configured to outwardly deploy into a larger size scoop 20. The foldable rods may be deployable by the stowed strain energy when folded or by mechanical methods (e.g. springs and hinges) that connect via incremental lengths to the funnel 22. In yet another alternative, a motorized system of driven hinges could also deploy a system of separate rods that support the funnel 22 and rings 24a. These alternative deployment methods could be selected depending on spacecraft mounting interface and scoop 20 size. In various embodiments, scoop 20 may be adjustably positioned to capture the flow of space plasma at or beyond any of a variety of orbits, such as a low earth orbit (LEO), a medium earth orbit (MEO), and a geosynchronous earth orbit (GEO). For example, in LEO, inlet 22a of scoop 20 may be adjustably oriented in the direction in which the spacecraft is traveling (or the “RAM” direction). In MEO, GEO or interplanetary space operations, inlet 22a of scoop 20 may be adjustably oriented in the direction from which the optimal flow of space plasma is received by scoop 20.

MHD power system 1 also preferably includes a power control unit 30 operable to manage electrical power generated and output by MHD power system 1. An exemplary power control unit 30 can be seen in the embodiment of FIG. 5. Referring to FIG. 5, Power control unit 30 generally includes an electromagnet control circuit 36, a voltage regulating circuit 32, an plasma guide control circuit 34, and a controller 38. Controller 38 is in operative communication with electromagnet control circuit 36, voltage regulating circuit 32, and/or plasma guide control circuit 34 via electrical and/or data connections, which may be wired or wireless communication links, such as links 37, for example, to manage or otherwise control the distribution of electrical power received from a power source (e.g., MHD channel 10 or energy storage device 33) to plasma scoop 20, MHD channel 10, the electrical system of the spacecraft, or elsewhere as appropriate to perform the operations and objectives of MHD power system 1 described herein. Controller 38 includes a computer which may be embodied by hardware resources for executing software instructions, including, for example, a memory 38a, such as a random access memory (“RAM”) and/or read-only memory (“ROM”), a processor 38b, such as a central processing unit (“CPU”) or a microprocessing unit (“MPU”), input/output (I/O) ports, and a plurality of peripherals (e.g., comparators, timers, frequency modulators, and/or different circuitry or functional components). Operating logic that defines various control, management, and/or regulation functions, such as operating logic 60, may be stored as software instructions in memory 38a and referenced by processor 38b to execute the operating logic. One or more sensors 35 (e.g., current sensor(s) 35b, 35c, 35e, voltage sensor(s) 35a, density sensor(s) 35d, and/or frequency sensor(s)) may be disposed at voltage regulating circuit 32, electromagnet control circuit 36, plasma guide control circuit 34, and other locations to detect and communicate data of space plasma conditions (e.g., density (ρᵢ) or velocity) and power (e.g., current(s) (Iₚₒᵤₜ, Iₘ, I_{sc}), voltage(s) (V_{c}), or frequency). Processor 38b of controller 38 may be in communication with sensors 35 to receive data as inputs to operating logic.

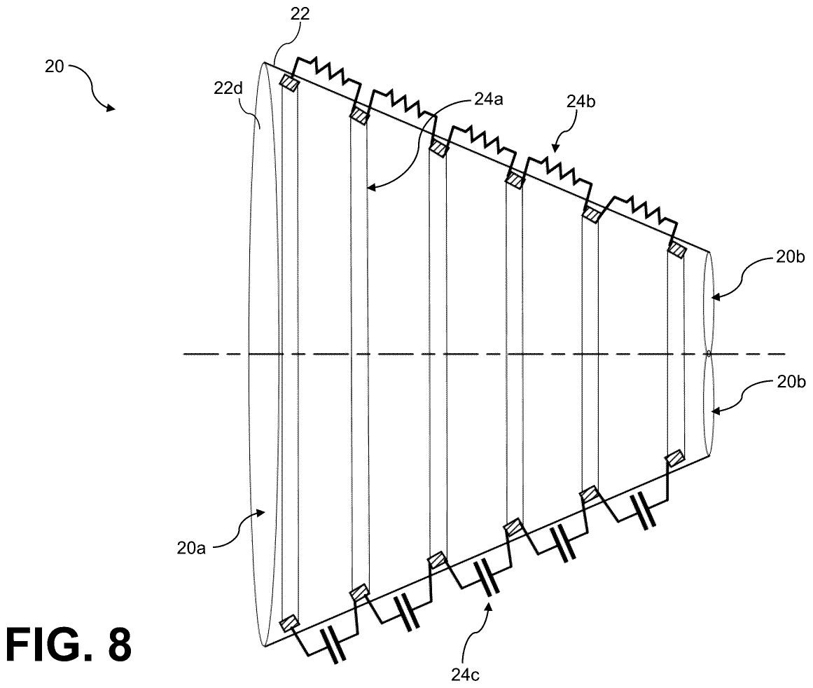

Plasma guide 24 is operable to direct and accelerate the flow of space plasma through MHD channel 10. Plasma guide 24 may be embodied by a stacked-ring plasma guide. As shown in the exemplary plasma scoop 20 of FIG. 8, Plasma guide 24 includes a plurality of spaced-apart electrode rings 24a, which may be embodied by conductive bands, wires, strips or the like, defining a set of apertures whose centers define a center axis and whose diameters decrease from inlet 22a to exit 22b along the center axis. As shown in FIG. 8, plasma guide 24 also includes a series of small resistors 24b respectively disposed between rings 24a on a first side of rings 24a, and a series of small capacitors 24c respectively disposed between rings 24a on a second side of rings 24a opposite the first side. Plasma guide 24 is electrically coupled to plasma guide control circuit 34. Out-of-phase radiofrequency (RF) voltages from plasma guide control circuit 34 may be applied as an RF voltage signal to rings 24a via capacitors 26c such that the RF phase applied to each ring 24a is different from the RF phase applied to any immediately adjacent ring, which induces rings 24a to provide an oscillating electric field within plasma guide 24 that confines the flow of space plasma toward the center axis. DC voltages may also be applied as a DC voltage signal from plasma guide control circuit 34 gradiently across resistors 24b to create a monotonically progressive voltage gradient along the length of plasma guide 24, decreasing from a first aperture near inlet 22a to a last aperture near exit 22b, to drive the space plasma into channel 12.

Plasma guide control circuit 34 may be controlled by controller 38 to control the electric field and voltage gradient within plasma guide 24 based at least in part on data indicative of the density of the space plasma. Plasma guide control circuit 34 includes oscillation circuitry configured to output RF voltages of different phases within a range of frequencies (e.g., 600 kHz to 700 kHz) to rings 24a of plasma guide 24, and circuitry to output DC voltages across resistors 24b. A density sensor 35d, such as a faraday cup, is mounted on the spacecraft to detect a density of the space plasma entering system 1 and provide data indicative of the density to controller 38. Plasma guide control circuit 34 may be controlled by controller 38 in response to operating logic to apply and/or adjust the RF and DC voltages to rings 24a based at least in part on the density data received from density sensor 35d. Controller 38 is in communication with density sensor 35d to receive data indicative of the density of the space plasma and, based on said data, outputs a plasma guide control signal to plasma guide control circuit 34. The plasma guide control signal drives plasma guide control circuit 34 to apply RF and DC voltages to plasma guide 24 that correspond to a desired electric field and voltage gradient. The desired electric field and voltage gradient may correspond, for example, a desired electrical power output from MHD channel 10.

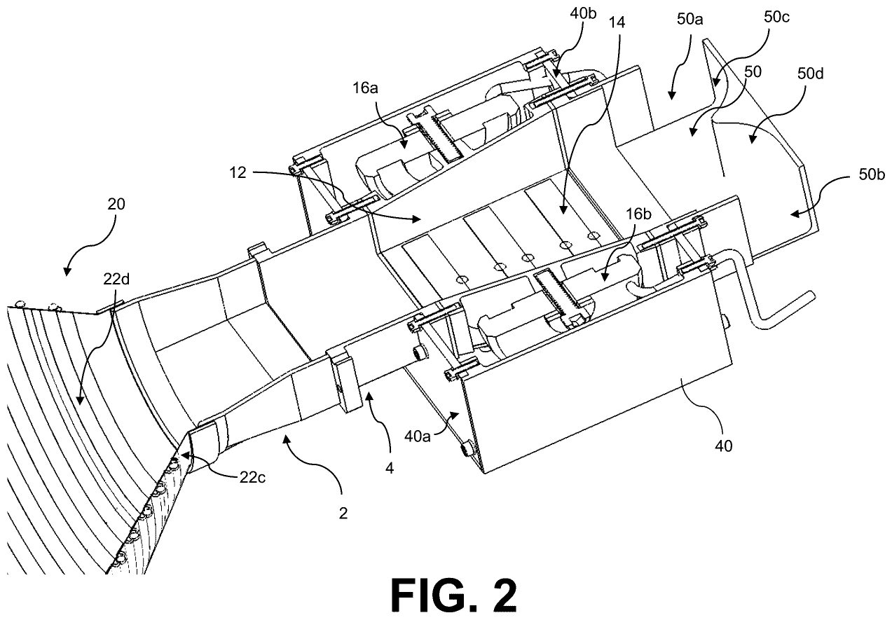

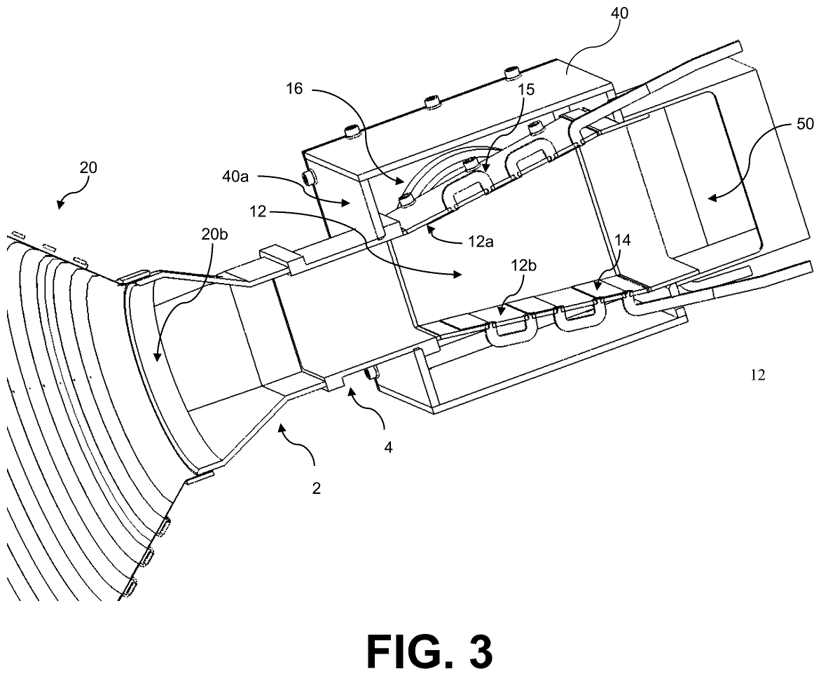

MHD channel 10 is in fluid communication with scoop 20 to receive the flow of space plasma from scoop 20. The exit 22b of scoop 20 may be mounted by an adapter 3 to a mounting flange 4 provided at the inlet of MHD channel 10. MHD channel 10 is operable to produce DC electrical power from the flow of space plasma. MHD channel 10 includes a channel 12, electrodes 14, electromagnets 16, and at least one permanent magnet. The at least one permanent magnet is oriented relative to channel 12 to produce a magnetic field inside channel 12 orthogonal to the flow of space plasma, which facilitates the production of electrical power prior to activating of electromagnets. Electromagnets 16 may be constituted by circular-shaped, wire-wound ferromagnetic cores positioned respectively on opposite sides of channel 12 operable to provide a magnetic field within channel 12 in response to an electromagnet power signal output by electromagnet control circuit 36 driven by controller 38 based on operating logic, such as electromagnet control logic 62. Electrodes 14 are provided in series electrical connection on internal surfaces of channel 12 within and orthogonal to the magnetic field and the flow of space plasma such that electrodes 14 receive DC electrical power in response to the space plasma flowing orthogonally through the magnetic field. For example, as shown in FIGS. 2 and 3, MHD channel 10 may have one electrode mounted on a top internal surface of channel 12 and another electrode mounted on a bottom internal surface of channel 12 opposite of the top internal surface.

MHD channel 10 is preferably accommodated inside an enclosure 40. Enclosure 40 is operable to limit the projection of the magnetic field generated by electromagnets 16 to prevent interference with spacecraft electronics, exterior RF signals or other peripheral magnetic sources. For example, enclosure 40 may be made of a ferromagnetic alloy with high permeability (preferably, Mu-Metal) and envelope MHD channel 10 as shown in the exemplary embodiment of FIG. 2. Enclosure 40 may be embodied, for example, by a box-shaped housing formed of plates defining an internal cavity, including a forward plate 40a and an aft plate 40b opposite forward plate 40a. Channel 12 may pass through the internal cavity of enclosure 40 between openings respectively formed in forward plate 40a and the aft plate 40b of enclosure 40. MHD power system 1 includes an exhaust section 50 comprising one or more exhaust ports 50a, 50b in fluid communication with channel 12 via one or more exhaust ducts 50c, 50d. Exhaust ducts 50c, 50d are in fluid communication with channel 12 to receive the flow of space plasma exiting channel 12 and direct said flow out of MHD power system 1 through the exhaust port(s) 50a, 50b.

The electrical power generated by MHD power system 1 at electrodes 14 may be expressed by the following equation:

$$P = \frac{{U}^{2} {B}^{2} σ}{4} ( A δ )$$

where the total electrical power output (P) of MHD power system 1 can be determined as a function of the velocity of plasma electrons (U), the magnetic field strength (B), the electrode surface (A), the distance between electrodes (δ), and plasma conductivity (σ). Space plasma conductivity may be expressed as a function of space plasma density by the following equation:

$$σ = \frac{{n}_{e} {e}^{2}}{{m}_{e} v}$$

where space plasma conductivity (σ) can be determined as a function of space plasma electron density (ne), atomic unit charge (e), which is 1.6×10⁻¹⁹ coulombs, electron mass (me), which is 9.1×10⁻³¹ kg, and collision frequency (v). The collision frequency of space plasma may be represented as 2.91×10⁻⁶ InΔ×Tₑ, where the coulomb logarithm (InΔ) is 15 and the electron kinetic temperature (Tₑ) is 1 eV. As such, the collision frequency is 4.365×10⁻⁵.

As expressed, the amount of electrical power generated by MHD power system 1 through electrodes 14 varies in response to changes in the space plasma density and velocity and the magnetic field provided inside channel 12 by electromagnets 16. Electromagnets 16 are electrically connected to electromagnet control circuit 36 to control the magnetic field provided inside channel 12. Electromagnet control circuit 36 includes power switches/gates, such as Insulated Gate Bipolar Transistors (IGBTs), controlled by Pulse Width Modulated (PWM) signals generated by controller 38 in response to operating logic, such as electromagnet control logic 62. Electromagnet control circuit 36 is preferably of a standard H-bridge configuration with four IGBTs. Controller 38 uses circuitry such as timers and/or comparators to deliver to electromagnet control circuit 36 a PWM signal having a duty cycle for achieving a desired magnetic field inside channel 12. The PWM signal selectively and independently drives gates/switches of electromagnet control circuit 36 to generate an electromagnet power signal modulated by the PWM signal sufficient to power electromagnets 16 to provide the desired magnetic field inside channel 12. The desired magnetic field of electromagnets 16 corresponds to a target electrical power output from MHD power system 1, such as electrical power equal to the electrical power demand of the spacecraft. The magnetic field of electromagnets 16 may be controlled by controller 38 varying the duty cycle of the PWM signal in response to electromagnet control logic. For example, an electromagnet power signal generated using a PWM signal having a duty cycle of 50% may power electromagnets 16 to provide a magnetic field inside channel 12. However, upon controller 38 detecting an increase in the electric current drawn by the spacecraft via the current sensor, controller 38 in response to electromagnet control logic may apply to electromagnets 16 an electromagnet power signal generated using a PWM signal having an increased duty cycle (e.g., 70%) to provide a magnetic field inside channel 12 that corresponds to an electrical power output of MHD power system 1 at a constant voltage and a current matching the increased current drawn by the spacecraft. Standard H-bridge circuitry also provides the capability to reverse current direction and magnetic field polarity, which is applicable to changes in polarity of the space plasma. An alerting device, such as a safety timer, may be disposed in the electromagnet control circuit and operable to alert an operator when a predetermined maximum electromagnet current value has been exceeded (i.e., the alerting device has been activated or “tripped”) more than a predetermined maximum number of occurrences (“maximum trip threshold”), such as three trips, determined by testing and the like to avoid or otherwise limit damage to constituent elements of power control unit 30.

The voltage at which electrical power is output by MHD channel 10 through electrodes 14 may vary in response to changes in the space plasma conditions (e.g., density and velocity) among various locations in space. For example, MHD channel 10 may output electrical power at a voltage within a range of 300 VDC to 700 VDC from space plasma at LEO. In at least one embodiment, MHD channel 10 may output electrical power at a voltage within a range of 390 VDC to 492 VDC from space plasma at LEO. In GEO and deep space, MHD channel 10 may output electrical power at a voltage within a range of 300 VDC to 50000 VDC. For example, in one embodiment, MHD channel 10 can output electrical power at a voltage within a range of 300 VDC to 1000 VDC. A constant voltage is preferable for powering the electrical system of the spacecraft. Thus, MHD channel 10 is preferably electrically connected to the electrical system of spacecraft through voltage regulating circuit 32. Voltage regulating circuit 32 is operable to maintain the electrical power output by MHD channel 10 through electrodes 14 at a constant DC voltage (e.g., 28 VDC or 120 VDC). Voltage regulating circuit 32 includes buck and/or boost circuitry and linear voltage regulation circuitry. Buck circuitry functions to step down the voltage range of electrical power output by MHD channel 10. For example, buck circuitry may step down electrical power output at a voltage ranging from 392 VDC to 492 VDC to electrical power at a voltage ranging from 15 VDC to 28 VDC. The linear voltage regulation circuitry receives the electrical power output from the boost and/or buck circuitry and outputs electrical power to the electrical system of the spacecraft at a constant DC voltage (e.g., 28 VDC or 120 VDC). An energy storage device 33, such as one or more batteries, is preferably provided inside spacecraft bus for storing electrical power. The energy storage device may be provided as a unitary part of MHD power system 1 or separate of MHD power system 1 as a part of the electrical system of the spacecraft. One or more switch(es) controlled by controller 38, such as switches 37a, 37b, may be disposed between MHD channel 10, energy storage device 33, and the electrical system of the spacecraft to selectively store electrical power in the energy storage device while supplying electrical power from MHD channel 10 in some modes of operation and supply electrical power from energy storage device 33 in other modes of operation.

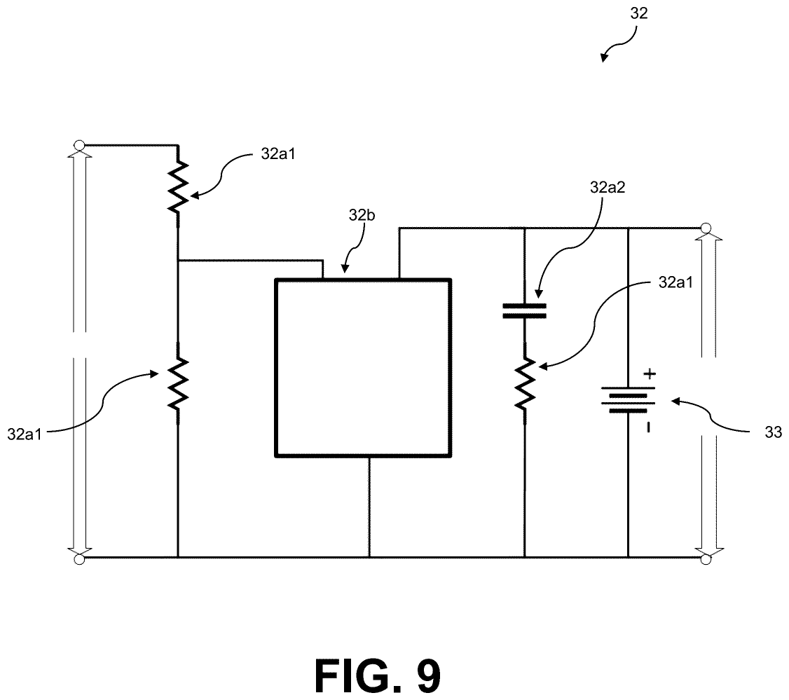

Operating logic of the MHD generation will be described hereinafter with reference to FIG. 9. FIG. 9 shows a diagram of exemplary operating logic. Referring to FIG. 9, operating logic 60 may include an electromagnet control logic 62, an RF control signal logic 64, and a voltage regulating logic 66.

Block 40 in FIG. 9 shows a diagram of an exemplary electromagnet control logic. Referring to FIG. 9, current sensor may sense a current drawn from electrical loads. Controller 38 may monitor and compare electrical power output by MHD power system 1 and data indicative of the electrical current drawn by the electrical load. If an increase or decrease in the electrical current drawn by the spacecraft is detected by controller 38 via sensor, controller 38 may adjust the duty cycle of the PWM signal applied to electromagnets 16 to adjust the magnetic field inside channel 12 to account for the increased or decreased electrical current drawn by the spacecraft. In other words, the duty cycle of PWM signal may be adjusted by controller 38 to increase or reduce the power generation of MHD system 1 accordingly to match the increased or decreased electrical current drawn by the spacecraft. Controller 38 also monitors the current of the electromagnet power signal output to the electromagnets 16 via current sensor. Upon controller 38 detecting a current of the electromagnet power signal exceeding a predetermined maximum electromagnet current threshold value, controller 38 may adjust the RF signal output to rings 24a of scoop 20 to decrease the voltage gradient provided within scoop 20, decelerating the flow of space plasma through MHD channel 10, if controller 38 has not detected more than a predetermined maximum trip threshold (e.g., three trips) from the alerting device, such as the safety timer indicated in FIG. 9. If controller 38 detects that the alerting device has been tripped more than the predetermined maximum trip threshold (e.g., three trips), controller 38 may stop outputting electrical power to electromagnets 16.

Block 41 in FIG. 9 shows a diagram of an exemplary plasma guide control logic. Controller 38 monitors the density of space plasma through a density sensor, such as faraday cup 39b, to determine whether the density of the space plasma exceeds a predetermined high density threshold. If the density does not exceed the predetermined high density threshold, controller 38 increases the RF/DC voltage signals output to rings 24a from plasma guide control circuit 34 to increase the electric field and voltage gradient provided inside scoop 20, accelerating the flow of space plasma through MHD channel 10. Upon detecting a space plasma density in excess of the predetermined high density threshold value, controller 38 decreases the RF/DC voltage signals output to rings 24a from plasma guide control circuit 34 to decrease the electric field and voltage gradient provided within scoop 20, decelerating the flow of space plasma through MHD channel 10.

Block 42 in FIG. 9 shows a diagram of an exemplary voltage regulating logic 66. Controller 38 monitors the voltages at which electrical power is input to and output from voltage regulating circuit 32. Upon detecting electrical power input to voltage regulating circuit 32 at a voltage exceeding a predetermined high MHD input voltage value or electrical power output from voltage regulating circuit 32 at a voltage exceeding the target constant voltage output, controller 38 decreases the duty cycle of the PWM signal applied to electromagnets 16 to weaken the magnetic field inside channel 12, reducing the electrical power output by MHD channel 10. Alternatively, controller 38 may decrease the RF/DC voltage signals applied to rings 24a to weaken the voltage gradient within scoop 20, decelerating the flow of space plasma through MHD channel 10 to reduce the electrical power output by MHD channel 10.

A method of using MHD power system 1 to power the electrical system of a spacecraft will be described hereinafter. The method includes providing a magnetic field inside channel 12 and directing via scoop 20 a flow of space plasma through channel 12, and, by directing the flow of space plasma through channel 12, passing the space plasma orthogonally through the first magnetic field. The method includes generating electrical power in response to passing the flow of space plasma orthogonally through the magnetic field, and outputting the electrical power from electrodes 14 to the electrical system of the spacecraft via voltage regulating circuit 32. By outputting the electrical power from electrodes 14 to the electrical system, powering the electrical system. The method may further include the steps of receiving, from one or more sensors 35 via controller 38, data indicative of at least one of a density of the space plasma and an electrical current drawn by the electrical system of the spacecraft; detecting a change in at least one of the density of the space plasma and the electrical current drawn by the electrical system based at least in part on the data; outputting, based at least in part on a detected change in at least one of the density of the space plasma and the electrical current drawn by the electrical system of the spacecraft, a control signal to one of plasma guide control circuit 34 and electromagnet control circuit 36, wherein the control signal is output to plasma guide control circuit 34 if the detected change is in the density of the space plasma and to electromagnet control circuit 36 if the detected change is in the electrical current drawn by the electrical system; in response to the control signal to at least one of plasma guide control circuit 34 and electromagnet control circuit 36, adjusting one of the voltage gradient within plasma scoop 20 and the magnetic field inside channel 12 to one of increase and decrease one of a velocity of the space plasma and a strength of the magnetic field; and, by at least one of increasing and decreasing one of the velocity of the space plasma and the strength of the magnetic field, adjusting the electrical power output from MHD power system 1 to the electrical system of the spacecraft to account for the detected change in at least one of the density of the space plasma and the electrical current drawn by the electrical system.

The principles, preferred embodiment, and mode of operation of the present invention have been described in this specification. In interpreting this specification, all of the terms used to describe the present invention should be given the broadest interpretation consistent with the context. For example, the terms “comprises,” “comprising,” “includes,” “including,” and “having,” are inclusive and therefore specify the presence of stated features, integers, steps, elements, operations, and/or components, but do not preclude the presence or absence of other features, integers, steps, elements, operations, components, and/or groups thereof. The conjunctive term “and/or,” or terms of similar import, shall be understood to be inclusive of any and all combinations of the items listed in connection with such term. Ordinal numbers, such as “first,” “second,” and “third,” are used to distinguish between various constituent elements for convenience and do not denote the order of constituent elements so distinguished. Further, directional terms, such as “top,” “bottom,” “upper,” “lower,” “left,” “right,” “upward,” and “downward,” are used to clarify and describe the relationship between various constituent elements of specific embodiments of the present invention, but do not denote absolute orientation. Therefore, such terms vary according to the orientation of the present invention. In addition to the foregoing terminological considerations, all references cited in this specification are hereby incorporated by reference insofar as there is no inconsistency with the disclosure of this specification. In addition, specific embodiments referenced in describing the present invention are not to be regarded as exhaustive or limiting to the full scope of the present invention. Other persons may modify the disclosed embodiments, or employ equivalents thereof, without departing from the scope and spirit of the present invention.

What is claimed is:

1. A magnetohydrodynamic (MHD) power generator for generating electrical power using space plasma, comprising:
a channel oriented in a first direction;
a plurality of magnets operable to provide a magnetic field inside the channel in a second direction orthogonal to the first direction; and
a plasma scoop in fluid communication with the channel and operable to direct a flow of space plasma through the channel to pass orthogonally through the magnetic field to generate electrical power.

2. The MHD power generator of claim 1, further comprising:
electrodes disposed inside the channel to conduct the electrical power generated by the flow of space plasma passing orthogonally through the magnetic field; and
a power control unit that comprises a voltage regulating circuit electrically coupled to the electrodes, wherein the voltage regulating circuit is operable to generate electrical power at a constant voltage based on electrical power received from the electrodes at a varying voltage.

3. The MHD power generator of claim 2, further comprising an enclosure in which the channel, the electrodes, and the plurality of magnets are accommodated.

4. The MHD power generator of claim 2, wherein the power control unit is configured to generate electrical power at least 27 VDC from electrical power at any voltage within a range of voltages between 389 VDC and 50,000 VDC.

5. The MHD power generator of claim 2, wherein the power control unit further comprises at least one energy storage device electrically coupled to the voltage regulating circuit to store at least a portion of the electrical power output by the voltage regulating circuit.

6. The MHD power generator of claim 5, wherein:
the power control unit further comprises a controller and a plasma guide control circuit, wherein the controller is electrically coupled to the at least one energy storage device to receive electrical power, and to the plasma guide control circuit; and
the plasma scoop comprises a conical funnel and a plasma guide fitted within the conical funnel, wherein the plasma guide control circuit is electrically coupled to the plasma guide and controlled by the controller to apply electrical power from one of the voltage regulating circuit and the at least one energy storage device to the plasma guide to produce an electrical field and a voltage gradient inside the plasma scoop operable to drive the flow of space plasma into the channel.

7. A system for powering an electrical system of a spacecraft, comprising:
a channel oriented in a first direction;
a plurality of magnets operable to provide a magnetic field inside the channel in a second direction orthogonal to the first direction, the plurality of magnets including a plurality of electromagnets and at least one permanent magnet;
a plasma scoop configured to direct a flow of space plasma through the channel to pass orthogonally through the magnetic field to generate electrical power, the plasma scoop comprising a conical funnel and a plasma guide fitted within the conical funnel;
electrodes disposed inside the channel orthogonal to the magnetic field and operable to extract at least a portion of the electrical power generated inside the channel; and
a power control unit electrically coupled to the electrical system of the spacecraft, the electrodes, the electromagnets, and the plasma guide.

8. The system of claim 7, wherein:
the plasma guide is configured to provide a voltage gradient inside the conical funnel operable to drive the flow of space plasma into the channel; and
the power control unit is configured to obtain data indicative of an electrical current drawn by the electrical system of the spacecraft and a density of the space plasma and, based the data, control at least one of the voltage gradient inside the plasma guide and the magnetic field inside the channel to output electrical power equal to the electrical power drawn by the electrical system of the spacecraft.

9. The system of claim 7, wherein the plasma guide comprises a plurality of spaced-apart electrode rings electrically interconnected via capacitors and resistors and fitted to a frustoconical inner peripheral surface of the conical funnel.

10. The system of claim 7, wherein the power control unit comprises:
a voltage regulating circuit electrically coupled to the electrodes and the electrical system of the spacecraft, wherein the voltage regulating circuit is configured to output electrical power to the electrical system based on electrical power received from the electrodes;
a plasma guide control circuit electrically coupled to the plasma guide;
an electromagnet control circuit electrically coupled to the electromagnets;
one or more sensors operable to detect at least an electrical current drawn by the electrical system of the spacecraft; and
a controller in operative communication with the one or more sensors, the plasma guide control circuit, the electromagnet control circuit, and the voltage regulating circuit, wherein the controller is configured to adjust an electrical power output from the voltage regulating circuit to equal the electrical power drawn by the electrical system of the spacecraft by controlling, based at least in part on data indicative of the electrical current drawn by the electrical system received from the one or more sensors, at least one of the plasma guide control circuit and the electromagnet control circuit to adjust respectively the voltage gradient inside the plasma scoop and the magnetic field inside the channel.

11. The system of claim 7, wherein the power control unit comprises:
a voltage regulating circuit electrically coupled to the electrodes and the electrical system of the spacecraft, wherein the voltage regulating circuit is configured to output electrical power to the electrical system based on electrical power received from the electrodes;
a plasma guide control circuit electrically coupled to the plasma guide;
an electromagnet control circuit electrically coupled to the electromagnets;
one or more sensors operable to detect at least a density of the space plasma and an electrical current drawn by the electrical system of the spacecraft; and
a controller in operative communication with the one or more sensors, the plasma guide control circuit, the electromagnet control circuit, and the voltage regulating circuit, wherein the controller is configured to adjust an electrical power output from the voltage regulating circuit to equal the electrical power drawn by the electrical system of the spacecraft by controlling, based at least in part on data indicative of the density and the electrical current drawn by the electrical system received from the one or more sensors, at least one of the plasma guide control circuit to adjust the voltage gradient inside the plasma scoop and the electromagnet control circuit to adjust the magnetic field inside the channel.

12. The system of claim 11, wherein the controller is configured to:
receive data indicative of the density of the space plasma from at least one density sensor;
detect a change in the density of the space plasma based on the data received from the at least one density sensor;
compare the changed density to a predetermined high density threshold value;
adjust a plasma guide control signal to decrease the voltage gradient in strength if the changed density exceeds the high density threshold value; and
provide the adjusted plasma guide control signal to the plasma guide control circuit, the plasma guide control circuit operable to adjust the voltage gradient in strength in response to the adjusted plasma guide control signal.

13. The system of claim 10, wherein the controller is configured to:
receive from one or more sensors data indicative of an electrical current output from at least one of the electrodes and the voltage regulating circuit and of an electrical current drawn by the electrical system of the spacecraft;
detect a change in the electrical current drawn by the electrical system of the spacecraft based on the data received from the one or more sensors;
compare the changed electrical current drawn by the electrical system of the spacecraft to the electrical current output from at least one of the electrodes and the voltage regulating circuit;
if the current output does not equal the current drawn by the electrical system, generate, based on the data received from the one or more sensors, a pulse width modulated (PWM) control signal having a duty cycle for achieving a magnetic field inside the channel which causes the voltage regulating circuit to output electrical power at an electrical current equal to the electrical current drawn by the electrical system of the spacecraft; and
provide the adjusted PWM control signal to the electromagnet control circuit, wherein the electromagnet control circuit is operable to adjust the electrical power applied to the electromagnets in response to the adjusted PWM signal to adjust the magnetic field.

14. A method of using the system of claim 7 to power an electrical system of a spacecraft using space plasma, comprising the steps of:
providing a magnetic field inside the channel via at least one of the plurality of magnets;
directing a flow of space plasma through the channel via the plasma scoop;
by directing the flow of space plasma through the channel, passing the space plasma orthogonally through a magnetic field inside the channel;
producing electrical power in response to passing the space plasma orthogonally through the magnetic field;
outputting the electrical power to the electrical system of the spacecraft via the voltage regulating circuit; and
by outputting the electrical power to the electrical system of the spacecraft via the voltage regulating circuit, powering the electrical system of the spacecraft.

15. The method of claim 14, further comprising the steps of:
receiving, from the one or more sensors via the controller, data indicative of at least one of a density of the space plasma and an electrical current drawn by the electrical system of the spacecraft;
detecting a change in at least one of the density of the space plasma and the electrical current drawn by the electrical system based at least in part on the data;
outputting, based at least in part on a detected change in at least one of the density of the space plasma and the electrical current drawn by the electrical system of the spacecraft, a control signal to one of the plasma guide control circuit and the electromagnet control circuit, wherein the control signal is output to the plasma guide control circuit if the detected change is in the density of the space plasma and to the electromagnet control circuit if the detected change is in the electrical current drawn by the electrical system;
in response to the control signal to at least one of the plasma guide control circuit and the electromagnet control circuit, adjusting one of the voltage gradient within the plasma scoop and the magnetic field inside the channel to one of increase and decrease one of a velocity of the space plasma and a strength of the magnetic field; and
by at least one of increasing and decreasing one of the velocity of the space plasma and the strength of the magnetic field, adjusting the electrical power output to the electrical system of the spacecraft to account for the detected change in at least one of the density of the space plasma and the electrical current drawn by the electrical system.

16. The method of claim 15, further comprising the step of repeating steps (a) through (e) at least one more time.
